(19) United States
(12) Patent Application Publication
(10) Pub. No.: US 2020/0385034 A1
(43) Pub. Date: Dec. 10, 2020

(54) HYBRID POWER SUPPLY SYSTEM OF DIESEL MULTIPLE UNIT AND POWER SUPPLY METHOD THEREOF

(71) Applicant: CRRC ZHUZHOU LOCOMOTIVE CO., LTD., Zhuzhou (CN)

(72) Inventors: Ying YANG, Zhuzhou (CN); Ande ZHOU, Zhuzhou (CN); Yunlong LI, Zhuzhou (CN); Libing FAN, Zhuzhou (CN); Tingfang LI, Zhuzhou (CN); Biao QI, Zhuzhou (CN)

(21) Appl. No.: 16/769,998

(22) PCT Filed: Dec. 26, 2017
(86) PCT No.: PCT/CN2017/118477

§ 371 Date: Jun. 4, 2020

(30) Foreign Application Priority Data
Dec. 8, 2017 (CN) 201711292990.0

(51) Int. Cl. B61L 3/00; B61C 7/04

(52) U.S. Cl. CPC B61L 3/006; B61C 7/04

(57) ABSTRACT

A hybrid power supply system of diesel multiple unit is disclosed. When a train is running, an energy management module sends a level signal of a master controller of the train to an inverter, and the inverter, according to the received level signal of the master controller and the dynamic performance of the hybrid power supply system, sets an envelope curve of train speed vs. traction force and an envelope curve of train speed vs. regenerative braking force to control a traction motor to output the corresponding torque. Further, the inverter, according to the voltage and current values acquired at the input end, calculates and sends a current actual demanded power to the energy management module, the energy management module, according to the current available power of a supercapacitor, calculates a required output power and sends a command of the required output power to a rectifier, and the rectifier, according to the command of the energy management module, controls the internal electric power pack to output corresponding power. The system is simple in structure and reliable in control, and can increase the dynamic performance of the train and improve the transportation capability of the train. A hybrid power supply method for a diesel multiple unit is also disclosed.

### FIELD OF THE INVENTION

The present invention relates to an internal power supply system of diesel multiple unit, in particular to a hybrid power supply system of a diesel multiple unit and power supply method thereof.

### BACKGROUND OF THE INVENTION

After years of development, the existing diesel multiple units have made great contributions to the development of human civilization and created direct or indirect economic benefits that are difficult to calculate. However, with the rapid development of rail transit technology in recent years, people increasingly recognize the harm of the existing diesel multiple units to the human environment. The deterioration of air quality caused by the emissions from operation of power systems of the existing diesel multiple units, the gradual lack of oil resources, the urgency of environmental protection, and the pressure of shortage of oil reserves are forcing people to consider the problems of the power systems of the diesel multiple units and the solutions of optimal demands. At the early 20th century, the United States General Electric Company, Canadian Railpower Hybrid Technologies Corporation and Japan Toshiba Corporation successively developed diesel multiple units powered by diesel engines and batteries. However, the hybrid diesel multiple units have not been widely used in the fields of rail transits at home and abroad due to their high costs and high maintenance expenses.

### SUMMARY OF THE INVENTION

The technical problem to be solved by the present invention is to provide a hybrid power supply system of diesel multiple unit and power supply method thereof to improve the power performance of the train and improve the transportation capability of the train.

In order to solve the above technical problems, the technical solution adopted by the present invention is: a hybrid power supply system of a diesel multiple unit, including:

an energy management module, configured to receive respective current voltage, current, actual available power, and current output power sent by an internal electric power pack, a rectifier, a supercapacitor, and an inverter for energy management;

the internal electric power pack, configured to send its own working parameters to the energy management module, and at the same time transmit energy and its own capability parameters to the rectifier;

the rectifier, configured to send its own working parameters to the energy management module, and at the same time transmit energy and its own capability parameters to the inverter;

the supercapacitor, configured to send its own working parameters to the energy management module, and at the same time transmit energy and its own capability parameters to the inverter; and

the inverter, configured to send its own working parameters to the energy management module, and at the same time supply the output electricity of the internal electric power pack and the supercapacitor to a traction motor to monitor the working state of the traction motor;

when the train is running, the energy management module sends a level signal of a master controller of the train to the inverter, and the inverter, according to the received level signal of the master controller and the dynamic performance of the hybrid power supply system, sets an envelope curve of train speed vs. traction force and an envelope curve of train speed vs. regenerative braking force to control the traction motor to output the corresponding torque; at the same time, the inverter, according to the voltage and current values acquired at the input end, calculates and sends a current actual demanded power to the energy management module, the energy management module, according to the current available power of the supercapacitor, calculates a required output power and sends a command of the required output power to the rectifier, and the rectifier, according to the command of the energy management module, controls the internal electric power pack to output corresponding power.

The hybrid power supply system includes two power supplies: the internal electric power pack and the supercapacitor, so the power supplied is sufficient, the start acceleration of the train is high, and the dynamic performance of the train is greatly improved.

When the train is in a traction mode, the internal electric power pack and the supercapacitor provide power in parallel to the traction motor and the on-board load; when the train is braked, the internal electric power pack runs at idle speed, the rectifier is standby, and the supercapacitor quickly recovers the regenerative braking energy of the traction motor; when the train is in an inert mode or a static mode, the internal electric power pack runs at idle speed to maintain the current running speed of the train while charging the supercapacitor; when the internal electric power pack fails and is isolated, the supercapacitor supplies power to the train load to maintain the power supply for a period of time; and when the supercapacitor fails and is isolated, the internal electric power pack supplies power to the train load to maintain the low-speed operation of the train.

In the present invention, the power of the internal electric power pack is 360 to 390 kW, and the power of the supercapacitor is 300 to 450 kW. The price and weight of a set of internal electric power pack are about 1.5 times those of the supercapacitor of the same power, so the hybrid power supply system of the present invention has the characteristics of light weight and low cost.

Correspondingly, the present invention also provides a hybrid power supply method for diesel multiple unit, including that:

when the train is in a traction mode, the energy management module judges whether the terminal voltage of the supercapacitor is greater than a first set voltage value of the supercapacitor; if the terminal voltage of the supercapacitor is greater than the first set voltage value (set to DC750V in the present invention), the energy management module controls the rectifier to be turned on, and the internal electric power pack and the supercapacitor supply power to the inverter together; if the terminal voltage of the supercapacitor is smaller than the first set voltage value, the energy management module controls the rectifier to be turned on, and the internal electric power pack charges the supercapacitor until the terminal voltage of the supercapacitor reaches the first set voltage value;

when the train is braked, the energy management module controls the internal electric power pack to run at idle speed and controls the rectifier to stand by, and at the same time, judges whether the current terminal voltage sent by the supercapacitor is greater than a second set voltage value of the supercapacitor; when the terminal voltage of the supercapacitor is greater than the second set voltage value, the energy management module controls the supercapacitor to be isolated, and the regenerative braking electricity is consumed by on-board devices and braking resistors; when the terminal voltage of the supercapacitor is smaller than the second set voltage value, the energy management module controls the supercapacitor to operate, and the regenerative braking electricity is absorbed by the supercapacitor and the on-board devices;

when the train is in an inert mode or a static mode, the energy management module controls the internal electric power pack to run at idle speed and controls the rectifier to operate, and at the same time, judges whether the current terminal voltage sent by the supercapacitor is greater than a third set voltage value of the supercapacitor; when the terminal voltage of the supercapacitor is greater than the third set voltage value, the energy management module controls the supercapacitor to be isolated; when the terminal voltage of the supercapacitor is smaller than the third set voltage value, the internal electric power pack charges the supercapacitor;

when the internal electric power pack fails, the energy management module controls the internal electric power pack and the rectifier to stop, and at the same time, judges whether the current terminal voltage sent by the supercapacitor is greater than a fourth set voltage value of the supercapacitor; when the terminal voltage of the supercapacitor is greater than the fourth set voltage value, the supercapacitor supplies power to the train load to maintain the power supply for a period of time; when the terminal voltage of the supercapacitor is smaller than the fourth set voltage value, the supercapacitor is first charged by an external power supply, and then the supercapacitor supplies power to the train load; and

when the supercapacitor fails, the energy management module controls the supercapacitor to be isolated, and controls the internal electric power pack to supply power to train traction loads and auxiliary loads.

Compared with the prior art, the present invention has the beneficial effects that the hybrid power supply system of the present invention includes two power supplies, so the power supplied is sufficient, the start acceleration of the train is high, and the dynamic performance of the train is greatly improved; because the supercapacitor participates in power supply, the output power of the internal electric power pack is greatly reduced when the train is running, which reduces the emission of pollution gas of the train, and the supercapacitor also has fast charge and discharge functions to achieve rapid recovery of train braking energy; and the present invention is simple in structure and reliable in control, and can greatly improve the dynamic performance of the train and improve the transportation capability of the train.

### BRIEF DESCRIPTION OF THE DRAWINGS

FIG. 1 is a circuit structure diagram of a hybrid power supply system according to the present invention;

FIG. 2 is a network connection diagram of the hybrid power supply system according to the present invention;

FIG. 3 is a configuration diagram of an internal electric power pack;

FIG. 4 is an internal configuration diagram of a rectifier;

FIG. 5 is an internal configuration diagram of a supercapacitor.

### DETAILED DESCRIPTION OF EMBODIMENTS

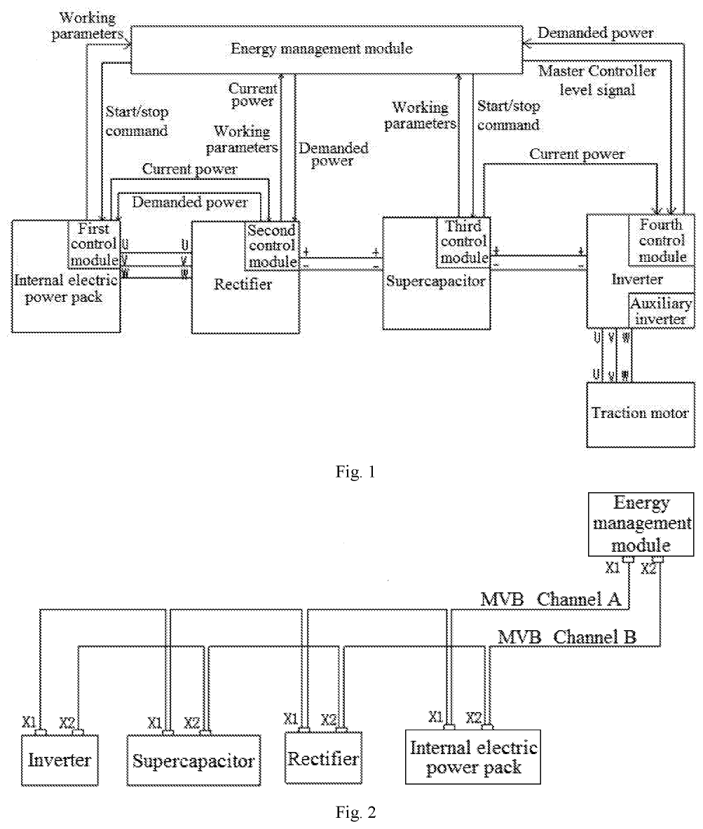

As shown in FIG. 1 and FIG. 2, a hybrid power supply system of the present invention includes:

An energy management module is configured to receive working states, current voltage, current, actual available power, and current output power sent by an internal electric power pack, a rectifier, a supercapacitor, and an inverter submodule themselves, and then perform calculation and energy management, thus achieving the advantages of fast response speed, strong dynamic performance and high braking energy recovery of the hybrid power supply system;

The internal electric power pack is connected to the energy management module through a multifunction vehicle bus (MVB) to send its own state and working parameters to the energy management module by using an MVB network, and is also connected to the rectifier through a power cable and a control cable to transfer energy from the internal electric power pack to the rectifier and send its own capability parameters to the rectifier;

The rectifier is connected to the energy management module through an MVB to send its own state and working parameters to the energy management module by using the MVB network, and is also connected to the inverter through a power cable and a control cable to transfer the energy of the power pack from the rectifier to the inverter and send its own capability parameters to the inverter;

The supercapacitor is connected to the energy management module through an MVB to send its own state and working parameters to the energy management module by using the MVB network, and is also connected to the inverter through a power cable to transfer energy from the supercapacitor to the inverter and send its own capability parameters to the inverter;

The inverter is connected to the energy management module through an MVB to send its own state and working parameters to the energy management module by using the MVB network, and is also connected to a traction motor through a power cable and a control cable to supply the output electricity of the internal electric power pack and the supercapacitor to the traction motor, and to monitor the working state of the traction motor;

The internal electric power pack and the supercapacitor are connected in parallel in a main circuit to achieve hybrid power supply and increase train output power at wheel rim.

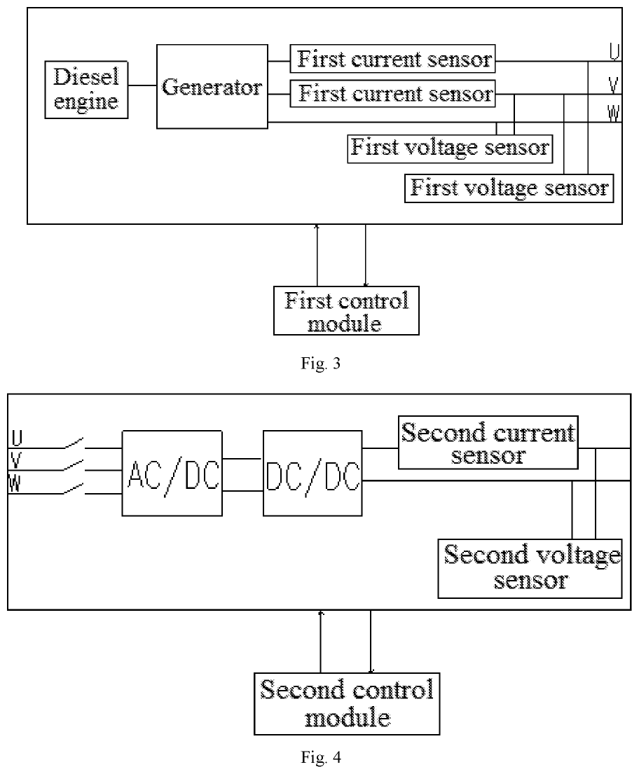

The internal electric power pack is equipped with a control machine case, and its output end is equipped with a voltage sensor and a current sensor, wherein the control machine case monitors the state of the internal electric power pack and controls the internal electric power pack to output corresponding power according to the command of the rectifier; the voltage sensor is configured to monitor the real-time output voltage of the internal electric power pack; the current sensor is configured to monitor the real-time output current of the internal electric power pack; and the circuit schematic diagram is shown in FIG. 3.

The rectifier is internally equipped with a control module, its input end is equipped with a contactor, and its output end is equipped with a voltage sensor and a current sensor. The control module monitors the state of the rectifier and controls the rectifier to output corresponding power according to the command of the energy management module; the contactor is configured to contact or isolate the rectifier; the voltage sensor is configured to monitor the real-time output voltage of the rectifier; the current sensor is configured to monitor the real-time output current of the rectifier; and the circuit schematic diagram is shown in FIG. 4.

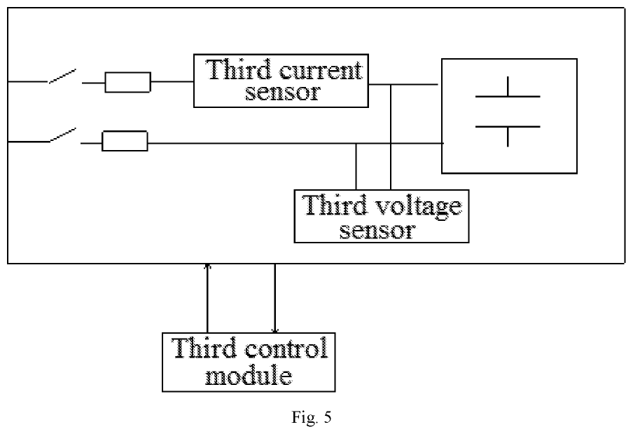

The supercapacitor is internally equipped with a control module, and its output end is equipped with a voltage sensor and a current sensor, a fuse and a contactor. The control module monitors the state of the supercapacitor; the voltage sensor is configured to monitor the real-time output voltage of the rectifier; the current sensor is configured to monitor the real-time output current of the rectifier; the fuse is configured to perform over-current protection; the contactor is configured to contact or isolate the supercapacitor; and the circuit schematic diagram is shown in FIG. 5.

Further, the supercapacitor also has fast charge and discharge functions to achieve rapid recovery of train braking energy.

The inverter includes a traction inverter and an auxiliary inverter and is internally equipped with a control module, its input end is equipped with voltage and current sensors and a contactor, and its output end is equipped with voltage and current sensors. The contactor is configured to contact or isolate the inverter; the control module monitors the state of the inverter and controls the traction motor to output corresponding torque according to the command of the energy management module; the voltage sensors are configured to monitor the real-time input and output voltage of the inverter; and the current sensors are configured to monitor the real-time input and output current of the inverter.

The traction motor is equipped with a speed sensor and a temperature sensor. The speed sensor is configured to monitor the speed of the traction motor, and the temperature sensor is configured to monitor the working temperature of the traction motor.

The supercapacitor is one of the main power supplies of the hybrid power supply system. Under the premise of the same output power requirements, the hybrid power supply system can be equipped with an internal electric power pack with low power, thereby reducing the emission of pollution gas and the production cost of the entire hybrid power supply system.

The hybrid power supply system according to the embodiment of the present invention includes one energy management module, one internal electric power pack, one rectifier, one supercapacitor, one inverter, four traction motors, and a set of MVB network.

The control strategy for the hybrid power supply system of the present invention is a direct torque plus power limit control strategy. When the train is running, the energy management module sends a level signal of a master controller of the train to the inverter, and the inverter, according to the received level signal of the master controller and the dynamic performance of the hybrid power supply system, sets an envelope curve of train speed vs. traction force and an envelope curve of train speed vs. regenerative braking force to control the traction motor to output the corresponding torque; at the same time, the inverter, according to the voltage and current values acquired at the input end, calculates and sends a current actual demanded power to the energy management module, the energy management module, according to the current available power of the supercapacitor, calculates a required output power and sends a command of the required output power to the rectifier, and the rectifier, according to the command of the energy management module, controls the internal electric power pack to output corresponding power.

When the train is in a traction mode, the internal electric power pack and the supercapacitor provide power in parallel to the traction motor and the on-board load.

When the train is braked, the internal electric power pack runs at idle speed, the rectifier is standby, and the supercapacitor quickly recovers the regenerative braking energy of the traction motor.

When the train is in an inert mode or a static mode, the internal electric power pack runs at idle speed to maintain the current running speed of the train while charging the supercapacitor.

When the internal electric power pack fails and is isolated, the supercapacitor supplies power to the train load to maintain the power supply for a period of time.

When the supercapacitor fails and is isolated, the internal electric power pack supplies power to the train load to maintain the low-speed (for example, less than 50 kilometers per hour) operation of the train.

In the circuit structure of the hybrid power supply system of the present invention, the power connection relationship is as follows: the three-phase output ends U, V, W of the internal electric power pack are connected to the corresponding three-phase input ends U, V, W of the rectifier; the positive and negative poles of the rectifier for outputting direct current are connected to the corresponding input positive and negative poles of the supercapacitor; the positive and negative output poles of the supercapacitor are connected to the corresponding positive and negative input poles of the traction inverter and the auxiliary inverter; the three-phase output ends U, V, W of the traction inverter are connected to the corresponding three-phase input ends U, V, W of the traction motor; the three-phase output ends and DC output end of the auxiliary inverter are connected to corresponding three-phase buses and DC bus of the train.

In the circuit structure of the hybrid power supply system of the present invention, the control connection relationship is as follows: the energy management module includes a plurality of control modules which communicate with respective components by MVBs, the WVBs are divided into two channels A and B that are mutually redundant; one wire of X1 of the internal electric power pack is connected to XI of the energy management module, the other wire of X1 of the internal electric power pack is connected to XI of the rectifier, one wire of X2 of the internal electric power pack is connected to X2 of the energy management module, and the other wire of X2 of the internal electric power pack is connected to X2 of the rectifier; the other wire of X1 of the rectifier is connected to X1 of the supercapacitor, and the other wire of X2 of the rectifier is connected to X2 of the supercapacitor; the other wire of X1 of the supercapacitor is connected to X1 of the inverter, and the other wire of X2 of the supercapacitor is connected to X2 of the inverter.

When the train is in a traction mode, the energy management module judges whether the terminal voltage of the supercapacitor is greater than a first set voltage value of the supercapacitor; if the terminal voltage of the supercapacitor is greater than the first set voltage value, the energy management module controls the rectifier to be turned on, and the internal electric power pack and the supercapacitor supply power to the inverter together; if the terminal voltage of the supercapacitor is smaller than the first set voltage value, the energy management module controls the rectifier to be turned on, and the internal electric power pack charges the supercapacitor until the terminal voltage of the supercapacitor reaches the first set voltage value.

When the train is braked, the energy management module controls the internal electric power pack to run at idle speed and controls the rectifier to stand by, and at the same time, judges whether the current terminal voltage sent by the supercapacitor is greater than a second set voltage value of the supercapacitor; when the terminal voltage of the supercapacitor is greater than the second set voltage value, the energy management module controls the supercapacitor to be isolated, and the regenerative braking electricity is consumed by on-board devices and braking resistors; when the terminal voltage of the supercapacitor is smaller than the second set voltage value, the energy management module controls the supercapacitor to operate, and the regenerative braking electricity is absorbed by the supercapacitor and the on-board devices.

When the train is in an inert mode or a static mode, the energy management module controls the internal electric power pack to run at idle speed and controls the rectifier to operate, and at the same time, judges whether the current terminal voltage sent by the supercapacitor is greater than a third set voltage value of the supercapacitor; when the terminal voltage of the supercapacitor is greater than the third set voltage value, the energy management module controls the supercapacitor to be isolated; when the terminal voltage of the supercapacitor is smaller than the third set voltage value, the internal electric power pack charges the supercapacitor.

When the internal electric power pack fails, the energy management module controls the internal electric power pack and the rectifier to stop, and at the same time, judges whether the current terminal voltage sent by the supercapacitor is greater than a fourth set voltage value of the supercapacitor; when the terminal voltage of the supercapacitor is greater than the fourth set voltage value, the supercapacitor supplies power to the train load to maintain the power supply for a period of time; when the terminal voltage of the supercapacitor is smaller than the fourth set voltage value, the supercapacitor is first charged by an external power supply, and then the supercapacitor supplies power to the train load.

When the supercapacitor fails, the energy management module controls the supercapacitor to be isolated, and controls the internal electric power pack to supply power to train traction loads and auxiliary loads.

The configuration rules of the hybrid power supply system of the present invention are: low-power internal electric power pack plus high-power supercapacitor (at present, the international internal electric power pack has a minimum power of about 390 kW and a maximum power of about 700 kW, and the present invention employs a power pack having a minimum power of 390 kW and a 450 kW supercapacitor). It is well known that the price and weight of a set of internal electric power pack is about 1.5 times those of a supercapacitor of the same power, so the hybrid power supply system of the present invention has the characteristics of light weight and low cost.

1. A hybrid power supply system of a diesel multiple unit, the hybrid power supply system comprising:
an energy management module, configured to receive respective current voltage, current, actual available power, and current output power sent by an internal electric power pack, a rectifier, a supercapacitor, and an inverter for energy management;
the internal electric power pack, configured to send its own working parameters to the energy management module, and at the same time transmit energy and its own capability parameters to the rectifier;
the rectifier, configured to send its own working parameters to the energy management module, and at the same time transmit energy and its own capability parameters to the inverter;
the supercapacitor, configured to send its own working parameters to the energy management module, and at the same time transmit energy and its own capability parameters to the inverter; and
the inverter, configured to send its own working parameters to the energy management module, and at the same time supply the output electricity of the internal electric power pack and the supercapacitor to a traction motor to monitor the working state of the traction motor;
when the train is running, the energy management module sends a level signal of a master controller of the train to the inverter, and the inverter, according to the received level signal of the master controller and the dynamic performance of the hybrid power supply system, sets an envelope curve of train speed versus traction force and an envelope curve of train speed versus regenerative braking force to control the traction motor to output the corresponding torque; at the same time, the inverter, according to the voltage and current values acquired at the input end, calculates and sends a current actual demanded power to the energy management module, the energy management module, according to the current available power of the supercapacitor, calculates a required output power and sends a command of the required output power to the rectifier, and the rectifier, according to the command of the energy management module, controls the internal electric power pack to output corresponding power.

2. The hybrid power supply system of the diesel multiple unit according to claim 1, wherein the internal electric power pack comprises a first control module; the first control module is connected to a first current sensor and a first voltage sensor; the first current sensor and the first voltage sensor are both connected to a generator; the generator is connected to a diesel engine; the first control module is configured to monitor the state of the generator and controls the internal electric power pack to output corresponding power according to the command of the rectifier, and the first voltage sensor is configured to monitor the real-time output voltage of the generator; and the first current sensor is configured to monitor the real-time output current of the generator.

3. The hybrid power supply system of the diesel multiple unit according to claim 2, wherein the rectifier comprises a second control module; the second control module is connected to a second voltage sensor and a second current sensor; the second voltage sensor and the second current sensor are both connected to a DC/DC converter; the DC/DC converter is connected to an AC/DC converter; the AC/DC converter is connected to the generator through a first contactor; the second control module is configured to monitor the state of the DC/DC converter and control the rectifier to output corresponding power according to the command of the energy management module; the first contactor is configured to contact or isolate the rectifier; the second voltage sensor is configured to monitor the real-time output voltage of the rectifier; and the second current sensor is configured to monitor the real-time output current of the rectifier.

4. The hybrid power supply system of the diesel multiple unit according to claim 3, wherein the supercapacitor comprises a third control module, and the third control module is connected to a third voltage sensor and a third current sensor; the input ends of the third current sensor and the third voltage sensor are connected to a fuse; the fuse is connected to the supercapacitor; the fuse is connected to the DC/DC converter through a second contactor; the third control module is configured to monitor the state of the supercapacitor; the third voltage sensor is configured to monitor the real-time output voltage of the supercapacitor, and the third current sensor is configured to monitor the real-time output current of the supercapacitor; the fuse is configured to protect over-current; the second contactor is configured to contact or isolate the supercapacitor.

5. The hybrid power supply system of the diesel multiple unit according to claim 1, wherein when the train is in a traction mode, the internal electric power pack and the supercapacitor provide power in parallel to the traction motor and the on-board load.

6. The hybrid power supply system of the diesel multiple unit according to claim 1, wherein when the train is braked, the internal electric power pack runs at idle speed, the rectifier is standby, and the supercapacitor quickly recovers the regenerative braking energy of the traction motor.

7. The hybrid power supply system of the diesel multiple unit according to claim 1, wherein when the train is in an inert mode or a static mode, the internal electric power pack runs at idle speed to maintain the current running speed of the train while charging the supercapacitor.

8. The hybrid power supply system of the diesel multiple unit according to claim 1, wherein when the internal electric power pack fails and is isolated, the supercapacitor supplies power to a train load to maintain the power supply for a period of time; and when the supercapacitor fails and is isolated, the internal electric power pack supplies power to the train load to maintain the low-speed operation of the train.

9. The hybrid power supply system of the diesel multiple unit according to claim 1, wherein the power of the internal electric power pack is 360 to 390 kW, and the power of the supercapacitor is 300 to 450 kW.

10. A hybrid power supply method for a diesel multiple unit, the hybrid power supply method comprising:
when a train is in a traction mode, determining, with a energy management module, whether a terminal voltage of a supercapacitor is greater than a first set voltage value of the supercapacitor; in response to the determining that the terminal voltage of the supercapacitor is greater than the first set voltage value, controlling, with the energy management module, a rectifier to be turned on, and supplying a internal electric power pack and the supercapacitor supply power to a inverter together; in response to determining that the terminal voltage of the supercapacitor is smaller than the first set voltage value, controlling, with the energy management module, the rectifier to be turned on, and charging, with the internal electric power pack, the supercapacitor until the terminal voltage of the supercapacitor reaches the first set voltage value;
when the train is braked, controlling, with the energy management module, the internal electric power pack to run at idle speed and the rectifier to stand by, and at the same time, determining whether the current terminal voltage sent by the supercapacitor is greater than a second set voltage value of the supercapacitor; in response to determining that the terminal voltage of the supercapacitor is greater than the second set voltage value, controlling, with the energy management module, the supercapacitor to be isolated, and consuming, with on-board devices and braking resistors, the regenerative braking electricity; in response to determining that the terminal voltage of the supercapacitor is smaller than the second set voltage value, controlling, with the energy management module, the supercapacitor to operate, and absorbing, with the supercapacitor and the on-board devices, the regenerative braking electricity;
when the train is in an inert mode or a static mode, controlling, with the energy management module, the internal electric power pack to run at idle speed and the rectifier to operate, and at the same time, determining whether the current terminal voltage sent by the supercapacitor is greater than a third set voltage value of the supercapacitor; in response to determining that the terminal voltage of the supercapacitor is greater than the third set voltage value, controlling, with the energy management module, the supercapacitor to be isolated; in response to determining that the terminal voltage of the supercapacitor is smaller than the third set voltage value, charging, with the internal electric power pack, the supercapacitor;
when the internal electric power pack fails, controlling, with the energy management module, the internal electric power pack and the rectifier to stop, and at the same time, determining whether the current terminal voltage sent by the supercapacitor is greater than a fourth set voltage value of the supercapacitor; in response to determining that the terminal voltage of the supercapacitor is greater than the fourth set voltage value, supplying, with the supercapacitor, power to a train load to maintain the power supply for a period of time; in response to determining that the terminal voltage of the supercapacitor is smaller than the fourth set voltage value, charging the supercapacitor first by an external power supply, and then supplying, with the supercapacitor, power to the train load; and
when the supercapacitor fails, controlling, with the energy management module, the supercapacitor to be isolated, and the internal electric power pack to supply power to train traction loads and auxiliary loads.
